(19) United States
(12) Patent Application Publication
(10) Pub. No.: US 2017/0300313 A1
(43) Pub. Date: Oct. 19, 2017

(54) METHOD AND SYSTEM FOR DOWNLOADING AND INSTALLING A REMOTE SOFTWARE UPDATE ON A VEHICLE

(71) Applicant: GM Global Technology Operations LLC, Detroit, MI (US)

(72) Inventors: Gary W. Gantt, JR., Chesterfield Township, MI (US); Mark J. Rychlinski, Farmington Hills, MI (US); Varsha Sadekar, Detroit, MI (US); David W. Walters, Sterling Heights, MI (US)

(21) Appl. No.: 15/098,650

(22) Filed: Apr. 14, 2016

(51) Int. Cl. G06F 9/445; H04L 29/08

(52) U.S. Cl. CPC G06F 8/65; H04L 67/12; H04L 67/34

(57) ABSTRACT

A method and system for downloading and installing software to a vehicle that includes a battery and vehicle electronics. The system includes a vehicle communications device that receives an anticipatory signal indicating that software is ready or will be ready for wireless download to the vehicle. In response to the anticipatory signal, the method and system determine whether the vehicle is in a state and/or the battery has enough energy for wireless download of the software package, installation of the software, or both. If the vehicle is not in such a state or the battery does not have the requisite energy, then changes to battery charging parameters may be made in preparation of the software download and/or installation.

### FIELD

The present invention generally relates to remote software updates for a vehicle and, more particularly, to a method and system for downloading and installing a remote software update on a vehicle that aim to increase the likelihood of a successful update.

### BACKGROUND

In the last decade, there has been a continuing increase in on-board vehicle technologies. Such technologies include wireless communications between the vehicle and other remote network devices or entities. For example, nowadays, generally all new vehicles include one or more modules that communicate information back to a remote facility, such that they provide data thereto. The corollary is also true; remote facilities provide vehicles with data via wireless communication systems, such as cellular networks.

Additionally, vehicles are being produced with integrated and extensive computer systems that enable operation of the vehicle for increased vehicle performance and user experience. However, updating or installing new software or firmware on some of these electronic devices, modules, or computers requires a user to bring their vehicle into a dealership. This can be very inconvenient for both users and dealerships, as well as costly for both. With the processing power and means of wireless communication that most new vehicles have, over the air (OTA) programming may be both a cost-effective and more convenient alternative. Nonetheless, a successful download and installation must be ensured such that no vehicle modules or devices are corrupted thereby necessitating that the vehicle be brought in to be fixed, which would frustrate the purpose. Moreover, because there are so many vehicles that may require one or more updates, decreasing the percentage of vehicles that need to be brought in to receive an update may be very beneficial.

### SUMMARY

According to one aspect, there is provided a method for downloading and installing software to a vehicle that includes a battery and vehicle electronics. The method may comprise the steps of: receiving an anticipatory signal at the vehicle indicating that a software package is ready or will be ready for wireless download to the vehicle, the software package includes software to be installed on the vehicle electronics; obtaining an energy threshold level from the anticipatory signal, the energy threshold level corresponds to the expected amount of energy needed for wireless download of the software package, for installation of the software, or for both wireless download of the software package and installation of the software; determining an energy level of the battery; comparing the energy level of the battery to the energy threshold level; and when the energy level of the battery is less than the energy threshold level, then making changes to battery charging parameters so that the energy level of the battery is increased. The changes to the battery charging parameters are made before the wireless download of the software package, before installation of the software, or before both the wireless download of the software package and installation of the software.

According to another aspect, there is provided a method for downloading and installing software to a vehicle that includes a battery and vehicle electronics. The method may comprise the steps of: receiving an anticipatory signal at the vehicle indicating that a software package is ready or will be ready for wireless download to the vehicle, the software package includes software to be installed on the vehicle electronics; obtaining a requisite charge mode for the vehicle, wherein the requisite charge mode corresponds to a mode of charging the battery that is preferable for wireless download of the software package, for installation of the software, or for both wireless download of the software package and installation of the software; determining a current charge mode for the vehicle; evaluating whether the current charge mode is the requisite charge mode; and when it is determined that the current charge mode is not the requisite charge mode, then making changes to battery charging parameters so that the battery energy level is increased. The changes to the battery charging parameters are made before the wireless download of the software package, before installation of the software, or before both the wireless download of the software package and installation of the software.

According to another aspect, there is provided a vehicle system for downloading and installing software. The system may comprise: a battery that powers one or more vehicle components; a wireless communications device powered by the battery and configured to wirelessly receive an anticipatory signal indicating that software is ready or will be ready for wireless download to the vehicle; and a vehicle module powered by the battery, coupled to the wireless communications device, and configured to compare an energy level of the battery to an energy threshold level obtained from the anticipatory signal. The system is configured to make changes to battery charging parameters so that the energy level of the battery is increased in preparation for downloading and installing the software when the energy level of the battery is less than the energy threshold level.

### DRAWINGS

Preferred exemplary embodiments will hereinafter be described in conjunction with the appended drawings, wherein like designations denote like elements, and wherein:

FIG. 1 is a block diagram depicting an exemplary embodiment of a system that may be used to download and install a remote software update on a vehicle;

FIG. 2 is a flowchart illustrating an exemplary embodiment of a method that may be used to download and install a remote software update on a vehicle, and the method may be used with the system of FIG. 1; and

FIGS. 3-6 are flowcharts showing more detailed embodiments of different steps from the method of FIG. 2.

### DESCRIPTION

The method and system described herein may be used to download and install software to a vehicle or to prepare a vehicle ahead of time for such an event so that the success rate of remote or over the air (OTA) software updates is improved. The method and system are preferably designed to send and receive communications to and from one or more remote locations, to perform vehicle functions in response to receiving communications, and then to download and install software to the vehicle from the one or more remote locations. In one embodiment, the vehicle may receive an anticipatory signal from a remote location, evaluate the anticipatory signal to determine an energy threshold level, change battery charging parameters if the battery is not above the energy threshold level, and then download and/or install the software to the vehicle. Additionally, the download and/or installation of the software may be performed upon detecting that the battery energy threshold level is satisfied, and the energy lost may be replenished after the download and/or installation is complete, if necessary, to cite two optional possibilities. This preparation helps ensure that the vehicle battery has enough charge or energy to carry out the download and installation of the software to the vehicle. In other embodiments, there may be a multitude of other factors, parameters, conditions, and/or states that may be evaluated and/or determined as a condition precedent to carrying out the download, installation, or both.

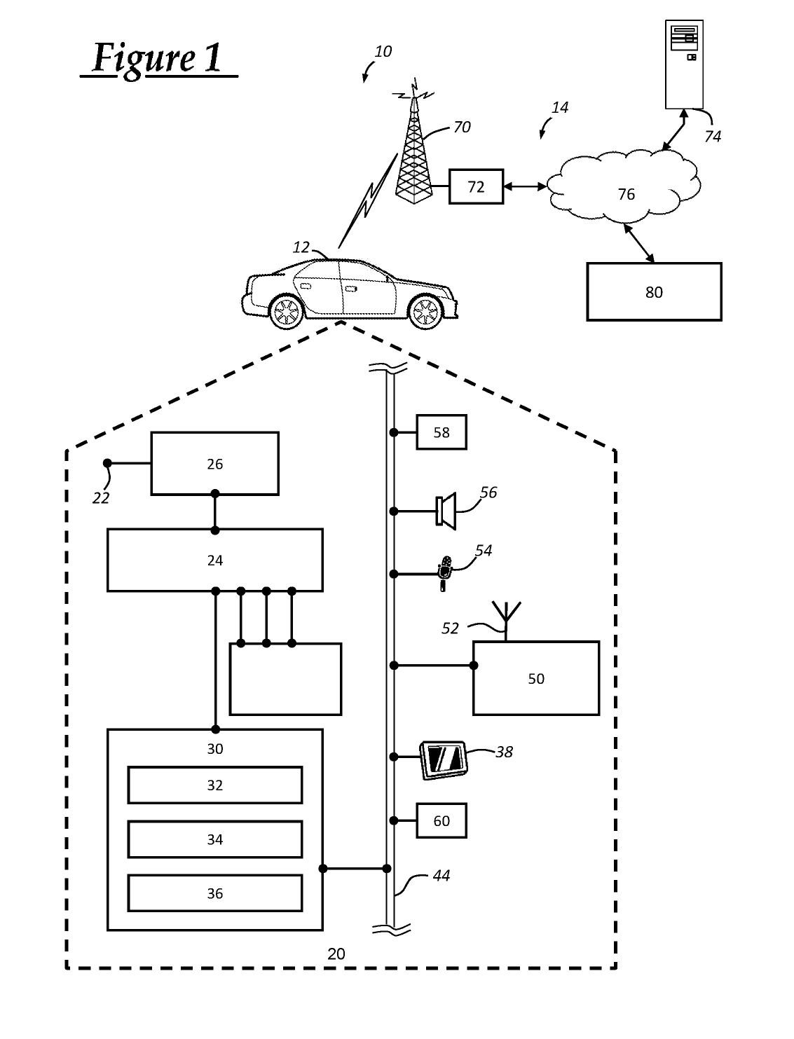

Referring now to the drawings, FIG. 1 depicts a potential embodiment of a system 10 for downloading and installing software to a vehicle, also referred to as a software push or over the air (OTA) programming. System 10 generally includes a vehicle 12, remote facility 80, and communications system 14. Vehicle 12 includes vehicle electronics 20 and battery 24, which, in some embodiments including the illustrated embodiment of FIG. 1, may be part of the vehicle electronics.

Vehicle 12 is depicted as a passenger car, but it should be appreciated that the present method and system may be implemented with other vehicles including motorcycles, trucks, sports utility vehicles (SUVs), recreational vehicles (RVs), marine vessels, aircrafts, trains, etc. Furthermore, vehicle 12 may be a traditional internal combustion engine vehicle, an electric vehicle, a hybrid vehicle, or any combination or derivative thereof.

Some components of vehicle electronics 20 that are more relevant to the present method are shown in FIG. 1, although skilled artisans will appreciate that a much more extensive collection of vehicle hardware exists in most modem vehicles. The vehicle electronics 20 may include battery 24, a charging circuit 26, telematics unit 50, a number of human-to-vehicle interfaces (e.g., Pedestrian Friendly Alert Function (PFAF) 56, speaker 56, visual display 38), and any number of vehicle modules, such as those shown in vehicle modules 30: body control module (BCM) 32, engine control module (ECM) 34, and other modules 36. These and other components of the vehicle electronics 20 may communicate with one another via a communication bus 44 or via a wireless network (not shown). It should also be appreciated that the vehicle electronics 20 shown in FIG. 1 is only for purposes of illustration, as the actual arrangement or configuration of components, devices, modules, and/or systems could vary substantially from that shown here and it is not limited to any particular embodiment. For instance, the BCM 32, ECM 34, and/or the other vehicle modules 36 may be stand-alone items or they may be combined or integrated with other components, devices, modules and/or systems in the vehicle. Put differently, the particular architecture of system 10 is one example, as the system could be provided according to myriad configurations and arrangements.

Battery 24 is used to power vehicle modules 30 and/or other electronics and may be incorporated as part of the vehicle electronics 20 by the OEM or may be installed into the vehicle as an aftermarket component. Battery 24 may be used to power a starting motor, interior and exterior lights, an ignition system and/or vehicle electronics, and may be of the type typically used in internal combustion engine vehicles (e.g., a standard 12 V or 24 V lead acid battery). In another embodiment, the battery may be used in a hybrid or electric vehicle for purposes of powering vehicle electronics, propelling the vehicle, or both (e.g., a 100-300 V lithium-ion or nickel-metal hydride battery). As shown, battery 24 is connected to a charging circuit 26 which may include one or more hardware components that provide the battery with the appropriate or desired amount of current, charge, and/or voltage. Additionally, charging circuit 26 may include devices or components that provide data concerning the battery 24, such as an Amp-hour meter that measures the Amp-hours that the battery can provide. In one embodiment, charging circuit 26 includes, or at least is coupled to, one or more alternators that charge the battery when the engine is running or the axle of the vehicle is rotating. In another embodiment, charging circuit 26 may be coupled and/or may include a regenerative braking apparatus such that the energy generated thereby is provided to battery 24. As mentioned previously and as illustrated in FIG. 1, battery 24 can provide one or more vehicle modules with energy. The battery can provide energy to these modules when the vehicle is running or can provide auxiliary power to vehicle modules when the vehicle is off.

Vehicle modules 30 may include BCM 32, ECM 34, other modules 36, or other devices that are included in vehicle electronics 20. One or more of the vehicle modules may be integrated with one another such that they operate using similar components, hardware, or software. Alternatively, the vehicle modules may be stand-alone modules and, if necessary or desired, may communicate with one another via a communications bus, such as bus 44. As shown in the illustrated embodiment, the vehicle modules are powered at least partly by battery 24. Depending on the specific configuration and desired operation of the vehicle electronics, the battery may or may not provide power to the vehicle modules when the vehicle is off.

Body control module (BCM) 32 and engine control module (ECM) 34 are shown as part of system 10. In one embodiment, BCM 32 and ECM 34 each include a processing device (not shown) and at least one memory device (not shown). If the vehicle has a memory device it may be RAM, ROM, other non-volatile memory, or, in the case of more than one memory device, the memory devices may be a combination thereof (e.g., a RAM device and a hard disk drive (HDD) (i.e. ROM)). The processing device may perform computations on data stored in the memory device or data that is received at the module via one or more communications busses, such as bus 44. The processing device may be used to write data received to memory, recall data to send to another device or module, and/or install software on its respective module or another module. In other embodiments, there may be one or more processing or memory devices that are shared among the vehicle modules. For example, BCM 32, ECM 34, and other modules 36 may share the same processing device and/or memory device. In addition, each module may have its own memory component or device whereupon software, firmware, or other computational instructions may be stored and/or installed.

Telematics unit 50 may be implemented as a wireless communications device. A “wireless communication device” broadly includes any device that can wirelessly receive an anticipatory signal indicating that software is ready or will be ready for download to the vehicle, as will be explained. Telematics unit 50 can be an OEM-installed (embedded) or aftermarket device that is installed in the vehicle and that enables wireless voice and/or data communication over communications system 14 and via wireless networking. This enables the vehicle to communicate with remote facility 80, computer 74, other telematics-enabled vehicles, or some other entity or device. Data can be sent either via a data connection, such as via packet data transmission over a data channel via communications system 14. The data may be received by one or more computers 74 (only one shown) or one or more facilities 80 (only one shown). Likewise, the telematics unit may receive data communications via communications system 14 from remote facilities 80, computers 74, or any other cellular device or network device that is connected to communications system 14 and/or land network 76. Antenna 52 is shown to be coupled to telematics unit 50 and may operate to improve the unit's ability to receive and transmit wireless data communications.

Other devices or components of vehicle electronics 20 include a pedestrian friendly alert system (PFAF) 58, speaker 56, microphone 54, and visual and/or touch display 38. These components, either solely or in combination with one another, may provide a human-to-vehicle interface such that an operator, passenger, or user of the vehicle may communicate with the vehicle and vice versa. These devices or components may be operated by one or more vehicle modules or units, such as telematics unit 50 or an infotainment module (not shown). In addition, these devices or components may be stand-alone, integrated into a module or with one another, or may be OEM-installed or aftermarket devices or components.

Wireless communications system 14 may be a cellular carrier system that includes a plurality of cell towers 70 (only one shown), one or more mobile switching centers (MSCs) 72 (only one shown), as well as any other networking components required to connect cell towers 70 with land network 76. Each cell tower 70 includes sending and receiving antennas and a base station, with the base stations from different cell towers being connected to the MSC 72 either directly or via intermediary equipment such as a base station controller. Communications system 14 can implement any suitable communications technology, including for example, analog technologies such as AMPS, or the newer digital technologies such as LTE, EVDO, CDMA, GPRS, and EDGE. As will be appreciated by those skilled in the art, various cell tower/base station/MSC arrangements are possible and could be used with communication system 14. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements.

Land network 76 may be a conventional land-based telecommunications network that is connected to one or more landline telephones and connects cell towers 70 to remote facility 80. For example, land network 76 may include a public switched telephone network (PSTN) such as that used to provide hardwired telephony, packet-switched data communications, and the Internet infrastructure. One or more segments of land network 76 could be implemented through the use of a standard wired network, a fiber or other optical network, a cable network, power lines, other wireless networks such as wireless local area networks (WLANs), or networks providing broadband wireless access (BWA), or any combination thereof. Furthermore, remote facility 80 need not be connected via land network 76, but could include wireless telephony equipment so that it can communicate directly with a wireless network.

Computer 74 can be one of a number of computers accessible via a private or public network such as the Internet. Each such computer 74 can be used for one or more purposes, such as providing software and/or information thereabout to vehicle 12. Other such accessible computers 74 can be, for example: a web server accessible by telematics unit 50 via communications system 14; a service center computer where diagnostic information and other vehicle data can be uploaded from the vehicle via the telematics unit 50; a client computer used by the vehicle owner or other subscriber for such purposes as accessing or receiving vehicle data or to setting up or configuring subscriber preferences or controlling vehicle functions; or a third party repository to or from which vehicle data or other information is provided, whether by communicating with the vehicle 12 or remote facility 80, or both. A computer 74 can also be used for providing Internet connectivity such as DNS services or as a network address server that uses DHCP or other suitable protocol to assign an IP address to the vehicle 12.

Remote facility 80 is designed to provide the vehicle electronics 20 with a number of different system back-end functions. In other embodiments, there may be more than one remote facility 80; however, as shown in the illustrated embodiment, there is only one remote facility presented for purposes of simplicity. One skilled in the art will appreciate that communications networks generally include multiple facilities and, accordingly, the functionality and/or operations provided herein that are disclosed with reference to a single remote facility may be extended to operate across more than one remote facility. Furthermore, computer 74 may be integrated or otherwise combined with remote facility 80, as it is expected that the remote facility would include any number of computers like computer 74.

The remote facility 80 may include one or more switches, servers, databases, live advisors, as well as an automated voice response system (VRS), all of which are known in the art. Remote facility 80 may include any or all of these various components and, preferably, each of the various components are coupled to one another via a wired or wireless local area network. Remote facility 80 may receive and transmit data via a modem connected to land network 76. A database at the remote facility can store software for vehicle modules or account information such as subscriber authentication information, vehicle identifiers, profile records, behavioral patterns, and other pertinent subscriber information. Data transmissions may also be conducted by wireless systems, such as 802.11x, GPRS, and the like. It should be appreciated that the modules, devices, and systems described herein are not limited to their schematic illustrations in FIG. 1 and/or their descriptions with respect to specific embodiments. These items may be provided in any number of different ways and it should be appreciated that FIG. 1 represents only one such embodiment.

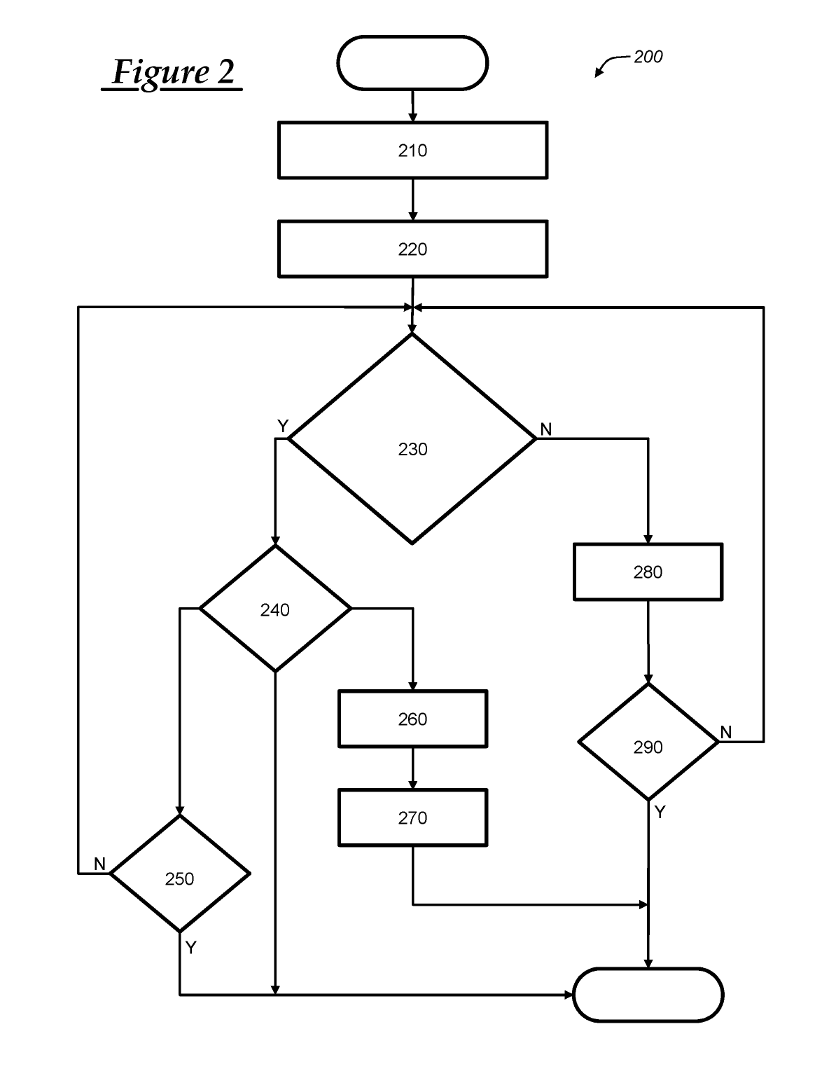

Turning now to FIG. 2, there is shown an exemplary embodiment of a method 200 for downloading and installing software to a vehicle that includes a battery and vehicle electronics.

Beginning with step 210, the method receives an anticipatory signal at the vehicle. The anticipatory signal indicates that a software package is ready or will be ready after a certain amount of time to be wirelessly downloaded to the vehicle. The software package includes software to be installed on the vehicle electronics and may include other data (e.g., metadata). The software may be new software or firmware, or it may be an update or patch to preexisting software or firmware, all of which is considered software for downloading and installing on the vehicle electronics. Thus, the terms “software” and “software update” are used interchangeably herein and can be part of a “software package.” It should be appreciated that, in some embodiments, the software package may solely consist of the software without any other data.

The anticipatory signal may include additional data, such as metrics about the software package (e.g., the size of the software package), the estimated installation time of software included in the software package, the origin of the signal, the date and time at which the software package will be ready for download, an energy threshold level, destination ECU(s) to be programmed, minimum communication busses needed to facilitate the update, etc. The anticipatory signal may be a wireless signal that is sent from a remote facility (e.g., a server at remote facility 80), from a computer (e.g., computer 74), from another vehicle, or from another device, component, or system that may wirelessly communicate with vehicle 12 (e.g., a mobile device such as a smartphone). The vehicle may receive this signal at telematics unit 50 via communications system 14. In another embodiment, the signal may be received by a mobile device (e.g., smartphone) from communications system 14 and then forwarded to vehicle 12.

After the anticipatory signal is received at vehicle 12, the method continues to step 220. At this step, the anticipatory signal is processed by the vehicle. This may include merely storing at least part of the data included in the signal. For example, the size of the software package or the estimated installation time of the software included in the software package may be stored to a memory device or medium, such as those that may be included in telematics unit 50, BCM 32, ECM 34, or other modules 36. In another embodiment, computations may be performed on at least part of the data of the anticipatory signal. For example, the anticipatory signal may include the size of the software package or size of the software included therein to be downloaded. An estimated installation time may then be computed using this software package or software size, along with other data that may be recalled from a memory device in vehicle electronics 20 or data that may be derived from the anticipatory signal, as indicated above in the preceding paragraphs.

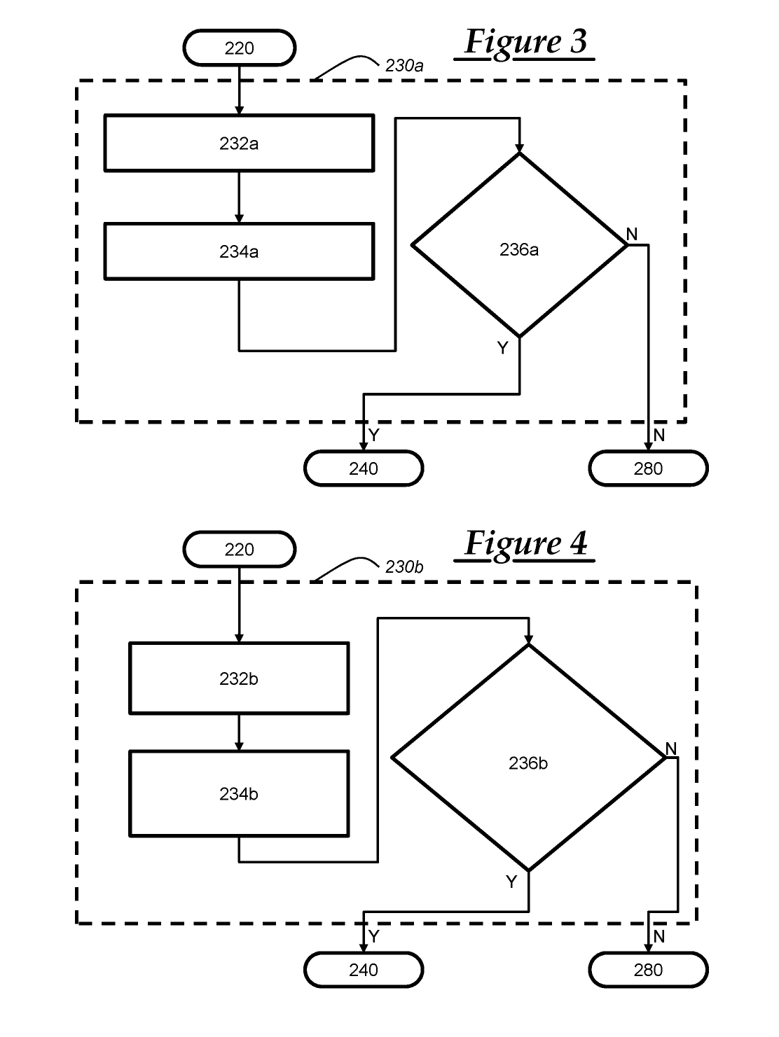

Step 230 may be carried out in a number of different ways and two such detailed embodiments are provided in FIGS. 3 and 4. A primary objective of step 230 is to determine whether the vehicle electronics 20 (which, as illustrated in FIG. 1, may include battery 24) are in a sufficient state for the software package to be downloaded, for the software to be installed, or for both the software package to be downloaded and the software to be installed to the vehicle. In this regard, one embodiment may provide carrying out both the detailed embodiments of step 230, steps 230a and 230b. Accordingly, the results of the decisional steps of the respective detailed embodiments (steps 236a and 236b) may be disjunctively or conjunctively combined to provide a determination for step 230 (e.g., if disjunctively combined, then a “Yes” from step 236a or a “Yes” from step 236b may indicate a “Yes” for step 230 whereas, if conjunctively combined, both steps 236a and 236b would need to result in a “Yes” for step 230 to result in a “Yes”).

Referring now to FIG. 3, step 230a, a detailed embodiment of step 230, is carried out. Step 230a, as shown in the illustrated embodiment, includes three steps: steps 232a, 234a, and 236a. At the first of these three steps, step 232a, an energy threshold level is determined from the anticipatory signal. The energy threshold level includes the expected amount of energy needed for wireless download of the software package, for installation of the software, or for both wireless download of the software package and installation of the software. As will be discussed below, this threshold level may subsequently be used to provide an indication, or at least a prediction, of the vehicle's capability of performing the downloading and installation steps.

In one embodiment, the energy threshold level may be a value (e.g., an Amp-hour value) that is contained in the anticipatory signal. Here, the energy threshold level is computed and then compiled into the anticipatory signal. This may be carried out by remote facility 80 or computer 74, for example, in a way similar to that which is described below with respect to the vehicle electronics (i.e. computing the threshold level by using the estimated installation time and other vehicle data). Then, in step 232a, the vehicle electronics may extract this value (i.e. the energy threshold value) from the anticipatory signal.

While, at least in the detailed embodiment of step 230a, the energy threshold level is determined from the anticipatory signal, this determination may also incorporate other data as well. Vehicle electronics 20 may use one or more processing devices, memory devices, and/or communication devices to compile and/or process data such that an energy threshold level may be converted into a common set of units. For example, the anticipatory signal may provide an installation time (e.g., 16 minutes) and vehicle electronics 20 may determine a current drain amount (e.g., 7 Amperes (A)). These values may be multiplied to provide a total drain per installation attempt (e.g., 7 A*(16 minutes/(60 minutes/1 hour))=1.867 Amp-hours). This converted value may be used as the energy threshold level or may be used to derive the energy threshold level, depending on the particular embodiment.

In another embodiment, the methods above may be utilized, but to the end that a certain state of the battery is ascertained instead of a specific value. For example, there may be certain predefined battery and/or vehicle electronics states that provide an indication as to one or more battery or vehicle electronics properties. Here, the anticipatory signal may provide the energy threshold level as “Energy Level 2.” As will be further described below in step 236a, this energy threshold level may be compared to the current energy level of the battery.

In step 234a, a battery energy level of the battery is determined. The battery energy level may be any indication of the battery's ability to provide energy. For example, the battery energy level may be in Amp-hours or may merely include an indicator of a certain state of the battery (e.g., “Energy Level 1,” wherein the battery's energy levels correspond to one or more energy levels or ranges). To determine the Amp-hours of the battery, the vehicle may use one or more devices electrically coupled to battery 24 or charging circuit 26. One such device may be an Amp-hour meter.

Since battery 24 is, at least in the illustrated embodiment, used to power multiple modules and/or other electronics, measuring the Amp-hours of the battery may not be sufficient in some cases and further calculations may need to be performed to determine the amount of energy needed by the specific module that will perform the installation of the software. For example, although battery 24 may be rated to provide 350 Amperes (A), the module that will perform the installation of the software, such as BCM 32, will most likely receive less amperage, such as 7 A. Those skilled in the art will appreciate that this may not be the case where the vehicle module (e.g., BCM 32) has its own dedicated battery (i.e. a dedicated battery may not provide more (or at least a non-nominal amount more) amperage than the module is rated for).

After the energy threshold level and battery energy level are determined, these values may be compared to one another, as illustrated in step 236a. This step may be carried out by any suitable device or module of vehicle electronics 20, computer 76 and/or remote facility 80, namely a device or module that has a processing device. For example, upon determining the values of the two energy levels to be compared, telematics unit 50 may use its processing device to determine whether the battery energy level is less than the energy threshold level.

In one embodiment wherein the energy levels are Amp-hour values, the processing device of telematics unit 50 may do a comparison of these two values (e.g., ENERGY_THRESHOLD_LEVEL>BATTERY_ENERGY_LEVEL). If the battery energy level is greater than or equal to the energy threshold level, then the method will be directed to step 240; otherwise, the method will be directed to step 280.

Referring now to FIG. 4, there is provided a second detailed embodiment of step 230 that is illustrated as step 230b wherein it contains three steps: 232b, 234b, and 236b. This embodiment of step 230 is similar to that of step 230a and everything discussed above with respect to step 230a (and the detailed steps contained therein) are incorporated into step 230b to the extent that they are relevant and consistent with the disclosure provided below.

In step 232b, a requisite state of the vehicle is determined. A requisite state of the vehicle is any state of the vehicle such that the vehicle is able to carry out the download of the software package, installation of the software, or both the download of the software package and installation of the software. One such embodiment includes representing the requisite state as a mode of operation of the vehicle electronics. A mode of operation may be any preconfigured operation or operations of the vehicle electronics that are to be carried out. One such example is a charge efficiency mode. Here, a charge efficiency mode is a mode of vehicle electronics 20 wherein the system voltage is lowered so as to improve fuel economy. Vehicle 12 may enter the charge efficiency mode when it is determined that the vehicle electrical demand is low and either the battery is very healthy or the battery is not accepting appreciable current at the optimal (or near-optimal) charging voltage. Put differently, the charge efficiency mode is a specific variant of the regular operating mode that targets a lower voltage when it is determined that the battery is not accepting appreciable current at the present, optimal (or near-optimal) charging voltage.

Similar to step 232a wherein the energy threshold level was determined, the requisite vehicle state may be determined. Here, the requisite state of the vehicle may be any representation or collection of vehicle electronics' properties, attributes, conditions, or modes of operation. For example, the requisite state may be contained in the anticipatory signal and determined therefrom simply by reading the anticipatory signal. In another embodiment, the vehicle may take data from the anticipatory signal, such as installation time or an amount of energy required for download and/or installation, and derive the requisite state therefrom. In another embodiment, the requisite state may be determined solely from information stored or gathered at the vehicle by vehicle electronics 20 and need not be derived from the anticipatory signal. In any event, after the requisite state has been determined, the method continues to step 234b.

In step 234b, the current state of the vehicle is determined. Here, the current state of the vehicle may be any representation or collection of vehicle electronics' properties, attributes, conditions, or modes of operation. As described above with respect to step 232b, the state of the vehicle may be described in terms of one or more of its current modes of operation, such as the charge efficiency mode. Alternatively, or in addition, the current state may be determined through determining one or more attributes, conditions, or properties of the vehicle electronics, such as the state of charge of the battery, the remaining Amp-hours of the battery, and/or the current mode(s) of operation. The method continues to step 236b.

After both the requisite state of the vehicle and the current state of the vehicle are determined, then step 236b is carried out to determine whether the current state of the vehicle is in the requisite state. This step may consist of a simple comparison, such as would be carried out if the requisite and current states were represented solely by modes of operation. Here, the evaluation would merely compare the requisite mode(s) of operation and the current mode(s) of operation and, upon the determination that the modes are the same or at least equivalent, the method will continue to step 240; otherwise, the method will continue to step 280. A mode of operation may be deemed equivalent to a non-identical mode of operation if the functionality and/or operation of the modes of operation are the same with respect to the determination of whether the vehicle electronics and/or battery are in a state such that the software may be downloaded and/or installed.

Returning back to FIG. 2, the method continues to step 240 upon step 230 evaluating to “Yes”. In step 240, the vehicle determines whether a user (e.g., operator or passenger of the vehicle) accepted or rejected the update which is provided in the software package; additionally, if no determination thereto can be made due to a lack of response by the user, then the step will evaluate to “No Response”. This step may be carried out after the vehicle prompts the user to indicate whether they accept or reject the update. The prompt may be provided by any of the human-to-vehicle interface means provided herein, such as via a textual prompt displayed on visual display 38, a spoken prompt provided by speaker 56, or a combination thereof.

The vehicle may then wait for a response from the user, which may be indicated via a spoken statement which can be received by microphone 54; or, the response may be received by the user pressing an on-screen button displayed on visual display 38. Upon reception of the user's indication, the method may proceed accordingly; that is, the method may proceed to step 260 if the user indicated their acceptance of the update or the method may end if the user rejected the update. In the case the user rejected the update, the method may carry out one or more previous steps instead of ending the method. For example, the method may prompt the user again to indicate whether they will now accept the update. Here, after a certain number of prompts provided to the user, the method may then end. It should be appreciated that this embodiment may be incorporated into the user bailout step (step 250) and, in that case, upon indication of a rejection, the method would continue to step 250 to determine if the number of rejections regarding the current software package has been exceeded; if so, the method ends (i.e. a “Yes” results from step 250) and, otherwise, the other detailed method steps (steps 252, 254, and 256) are carried out. In the case that the user does not provide a response or other indication, the method may continue to step 250 immediately or the vehicle may wait a certain amount of time before it continues to step 250.

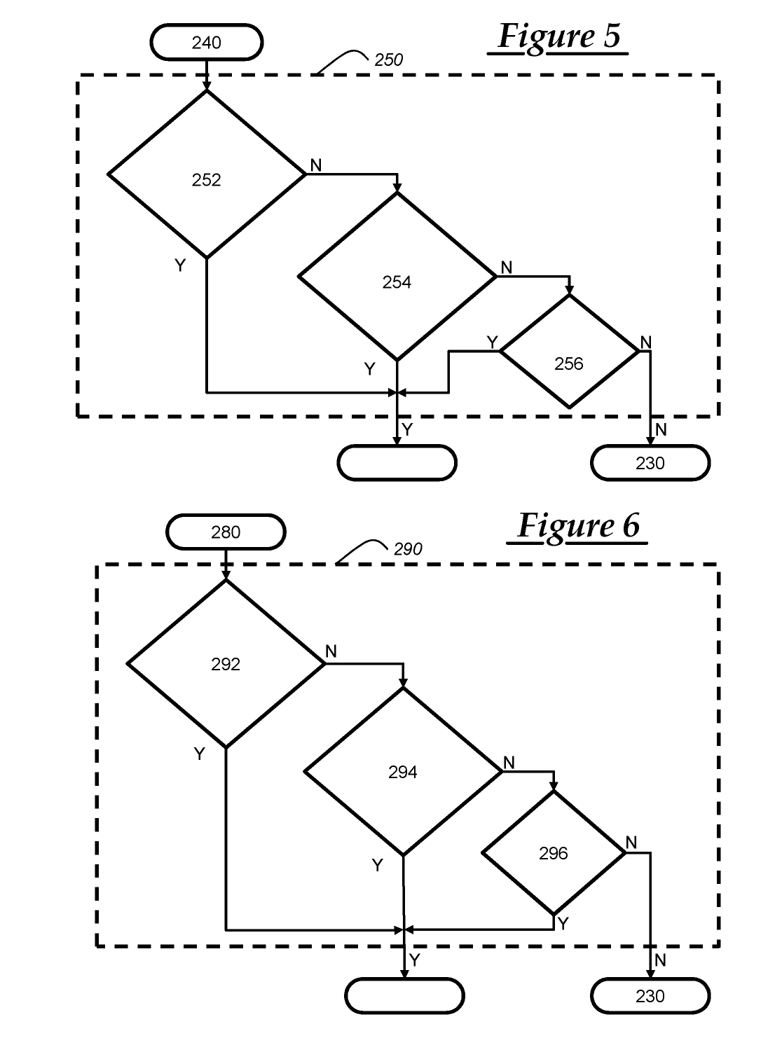

In step 250, it is determined whether there has been a “user bailout.” As used herein, a “user bailout” is an indication that the user has indicated, either explicitly or implicitly (e.g., by not accepting the installation of the update or software), that the software package download, software install, or both the software package download and software install should be abandoned or at least not carried out at the present time. In some embodiments, step 240 may be part of the user bailout as illustrated in step 250. There are many determinations that may be made to achieve this end, and some of them are highlighted in the detailed embodiment of step 250, which is illustrated in FIG. 5.

Referring now to FIG. 5, there is provided a detailed embodiment of step 250. To begin, in step 252 it is determined whether the vehicle has traveled more than a certain number of miles since an initial event. An initial event may be any event occurring before step 250 is reached and whereat an initial recording of one or more metrics, conditions, and/or attributes are recorded or, alternatively or in addition, whereat one or more variables are reset to a starting or initial value (e.g., setting NUM_MILES=0). In this step, it is determined whether the vehicle has traveled more than a certain amount of miles since the initial event. In one embodiment, the initial event may be when the user was prompted to indicate their response to whether the vehicle should install the update; or, in another embodiment, the initial event may be when the anticipatory signal was received.

Regardless, an initial recording of the number of miles the vehicle has traveled may be made at the initial event (e.g., when the user is prompted, as implicitly predicated in step 240). In one embodiment, this recording may be made by the vehicle electronics querying the odometer or other device that may have the current number of vehicle miles stored in memory. Depending on the certain implementation or embodiment, the vehicle may either store this value in memory, or may add the certain number of miles to this value and store this resulting sum. In the latter case, this sum may be regarded as the odometer threshold value. Then, when this step is reached, the vehicle electronics may ascertain the current number of miles the vehicle has traveled. The vehicle can then make a comparison of the threshold value (e.g., this resulting sum) to the amount of miles currently recorded. Upon the threshold value being exceeded, the step 250 evaluates to “Yes” and the method ends; otherwise, the method proceeds to step 254.

In step 254, a similar determination with respect to step 252 is made. Here, however, instead of determining the number of miles driven since the initial event, the number of ignition cycles thereafter is determined. An ignition cycle may be the period from the time the vehicle's ignition is engaged (or analogous event in hybrid and electric vehicles) to the time the vehicle's ignition is turned off (or up until the time the vehicle is turned on again after being turned off). In other embodiments, the period of time may be the same as which was previously described, but there may be one or more prerequisites that must be established such that the period is considered an ignition cycle. For example, a prerequisite may be the engine temperature reaching a certain temperature (e.g., such that it is “warmed up”). Put differently, if the engine is turned on and then turned off before the engine temperature reaches the certain temperature, then there was no ignition cycle (due to the fact that the prerequisite of the engine temperature reaching the certain temperature was not satisfied).

Regardless, the ignition cycle count may be set, or reset, to zero when the initial event is reached. Upon the vehicle detecting each ignition cycle, a counter stored in memory in vehicle electronics 20 may be incremented. Upon step 254 determining that the threshold number of ignition cycles (e.g., a predetermined value stored in the vehicle electronics) has been reached or exceeded, then the method may end; otherwise, the method may continue to step 256.

In step 256, the time between the initial event and the current time is evaluated. For example, as mentioned previously, the initial event may be when the user is initially prompted for the first time to indicate whether they accept the update. Upon this initial event, the time may be recorded to a memory device of vehicle electronics 20, such as to the memory device of telematics unit 50 or BCM 32. Then, upon reaching step 250, the current time may be compared to the initially recorded time and, subsequently, the result thereof may be compared to a threshold amount of time. This may be carried out by a processing device of vehicle electronics 20, such as the processing device included in BCM 32, ECM 34, other modules 36, or telematics unit 50. Upon the time expiring (i.e. the threshold amount of time exceeded by the difference in the current time and the initially recorded time), then step 250 evaluates to “Yes” and the method ends; otherwise, the method continues to step 230.

In step 260, after both the determination in step 230 provides that the vehicle electronics are in a state such that the update may be downloaded and/or installed (as further illustrated in steps 230a and 230b show in FIGS. 3 and 4, respectively) and the determination the user has accepted the update, the software package (e.g., update) is downloaded. The download may be initiated by the vehicle sending a request to download, such as an HTTP request, to a remote server. The request may indicate one or more properties about the vehicle or may merely indicate that the vehicle requests to download the software package. In another embodiment, it may be determined that the vehicle requests to download only one or more certain parts of the software package (e.g., software updates for the ECM 34), and not the entire package (e.g., where the entire package includes updates for BCM 32, ECM 34, and telematics unit 50).

After the server receives the request, the server may send the appropriate software package in accordance therewith. Here, the server may be a computer or similar device at remote facility 80, computer 74, or another vehicle. In any event, the software package may then be sent to and received by vehicle 12. The package need not be sent in one piece (e.g., in one data packet) and, if sent in the form of multiple packets, may be compiled at the vehicle. The vehicle may perform certain other processing on the package and/or record information regarding the package, such as data indicating successful reception of the package or parts thereof. The vehicle may then store the software package on one or more memory mediums or devices of vehicle electronics 20.

In another embodiment, the download may be carried out immediately after reception of the anticipatory signal. Here, the method would be carried out in the same manner except that the software package would be downloaded before carrying out step 230. Accordingly, step 230 would seek to determine if the vehicle is in the requisite state, wherein the requisite state represents a state of the vehicle such that the vehicle is able to carry out the installation of the software, or if the energy threshold level is greater than or equal to the battery energy level such that the threshold level includes the expected amount of energy needed for the installation of the software. In yet another embodiment, the anticipatory signal may include the entire software package to be subsequently installed on vehicle 12. In any event, a download may be paused and later resumed if interrupted through vehicle user intervention or any other type of interruption (e.g., loss of wireless network connection).

After the package is successfully downloaded, then the vehicle may carry out step 270 wherein the software included in the package is installed to the vehicle. As stated above, the software package may contain software for one or more vehicle modules. In one embodiment, before installation of the software to its corresponding module, the software package, which is currently stored in memory in vehicle electronics 20, should be processed such that the specific modules to which it shall be installed are identified. This may be performed by the processing device in telematics unit 50 or another processing device in any one of the vehicle modules.

Thereafter, the software may be analyzed to obtain requirements for the installation, such as the state that the vehicle must be in such that installation of the software may be carried out. For example, if the software is an update to be installed to ECM (engine control module) 34, it may be imperative that the vehicle is off (i.e., the ignition is not engaged) for the entire length of the installation process. In another example, the vehicle module to which the software is to be installed may be a compact-disc drive. Here, the installation may be carried out without any specific requirements of the vehicle state except that there must be enough power supplied to the module such that it has energy to perform the installation. In yet another example, the time between when the download finished and when step 230 was last carried out may be over a threshold amount of time such that the vehicle electronics may have changed states and/or depleted energy such that step 230, if carried out at the present time, is no longer satisfied. Therefore, depending on the amount of time between the completion of the download in step 260 and the last instance of carrying out step 230, it may be desirable to carry out step 230 again. If this is so, after step 230 is carried out such that it results in an affirmative result (i.e. “Yes”), then the method may skip to step 270 (since the user had already accepted the software in step 240 and the software is already downloaded (step 260)).

In any event, after it is determined that the vehicle is ready for installation of the software to one or more vehicle modules, the installation may be carried out. In one embodiment, a processing device included in BCM 32 may install the software to BCM 32. Installation may consist merely of writing a computer instruction to a memory device that is located at the module or that is accessible by the module. Alternatively, installation may refer to removing a portion of computer instructions from a module and then writing computer instructions contained in the software to the module. Skilled artisans will appreciate that the energy required for software installation oftentimes exceeds that needed for software package download.

In another embodiment, vehicle electronics 20 may carry out the installation through use of multiple modules. For example, if the software is to be installed to BCM 32, the processing device of telematics unit 50 can carry out the installation of the software thereto. This may be desirable or necessary where the installer unit (e.g., telematics unit 50) has greater processing power or capabilities than the module to which the software is to be installed. If the installation fails, or a reinstallation is desired, step 270 may be carried out again. In other embodiments, step 230 may be carried out again as well. Additionally, in the case of the software package containing software for multiple modules, the software may be installed in serial or parallel fashion. The method then ends.

Referring back to step 230, if therein it is determined that the vehicle is not in a state such that the vehicle electronics has the expected amount of energy needed for the software package to be downloaded, for the software to be installed, or for both the software package to be downloaded and the software to be installed to the vehicle, then step 280 is carried out. In step 280, changes are made to battery charging parameters so that the battery energy level is increased. In this way, the vehicle electronics may increase its chances of later satisfying the requirement of step 230 such that the software package may be downloaded, the software may be installed, or both the software package may be downloaded and the software may be installed to the vehicle.

As used herein, “battery charging parameters” refers to any parameter, condition, or attribute that is relevant to battery charging potential, capability, or capacity that may be changed, manipulated, altered, or otherwise modified by vehicle electronics 20. For example, vehicle electronics 20 may alter the current mode of operation of charging circuit 26 such that it provides the maximum (or near-maximum) practicable amount of current to battery 24. In another example, certain modules, components, or devices of vehicle electronics 20 may be disabled and/or set to a lower power mode such that energy is preserved. In yet another embodiment, the vehicle may prompt the user to charge battery 24 by plugging the vehicle into a charging device (e.g., this may be particularly employed in cases wherein the vehicle is an electric or hybrid vehicle). In cases of a hybrid or electric vehicle, the SOC or other parameters of a high voltage battery may be adjusted upwards. Additionally, a charge recovery mode that is designed to target a maximum allowed battery charging voltage may be carried out with changes to different battery charging parameters. One implementation of the charge recovery mode may be described as a battery maintenance mode designed to target the maximum allowed battery charging voltage for a set period of time on the vehicle, while inhibiting modes that allow intended battery charge depletion. Here, this mode may temporarily bypass other metrics that may normally target a more moderate charge cycle. A preparatory or anticipatory charge may be performed when it is determined that there is insufficient battery reserve capacity or it may be performed whenever an anticipatory signal is received, to cite two possibilities.

In step 290, one or more battery bailout conditions are evaluated to determine if they are satisfied. This is similar to the user bailout step (step 250) and, as illustrated in FIG. 6, a detailed embodiment of this step is provided. Similar to the user bailout step, an initial event is identified such that it may act as a starting point of comparison for one or more bailout criteria.

In step 292, it is determined whether a certain number of ignition cycles have passed since the initial event. This step is very similar to step 252 illustrated in FIG. 5 and described above and, accordingly, all relevant disclosure therein is incorporated herein such that it is relevant and consistent with the following description. For example, when step 280 is reached for the first time, a variable may be initialized to zero. Then, upon each ignition cycle (described above with respect to step 252), the counter may be incremented. Thereafter, this value may be compared to a predetermined or threshold value and, if the predetermined or threshold value is exceeded, then the battery bailout condition is satisfied and the method ends; otherwise, the next battery bailout condition may be evaluated, as shown in step 294.

In step 294, it is determined whether the vehicle has traveled a certain number of miles since the initial event (e.g., since the first time step 280 was reached for the present software package). Here, in one example, vehicle electronics 20 may record the number of miles the vehicle has traveled (e.g., the current odometer value) at the time of the initial event. Then, upon reaching step 294, the current odometer value may be read again and subsequently compared to the recording taken at the initial event. If the difference of these two values exceeds the certain number of miles, which may be a predetermined or threshold value, it can be said that the battery bailout condition is satisfied and then the method ends; otherwise, the method may continue to step 296.

In step 296, it is determined if a certain amount of time has passed since the initial event. Again, upon reaching the initial event, the time may be recorded. Then, upon reaching step 296, the difference in time (i.e. the amount of time that has passed since the initial event) may be compared to the certain amount of time, which may be a predetermined or threshold amount. Alternatively, one or more vehicle electronic conditions or parameters may inform what constitutes the certain amount of time. For example, upon reaching step 296, the battery temperature and/or other conditions or attributes may be measured by, for example, charging circuit 26. Upon one of these conditions or attributes falling out of a certain range of values that the condition is desired to be within or that the condition should be maintained within, then the bailout condition may be satisfied and the method ends; otherwise the method proceeds back to step 230.

It is to be understood that the foregoing description is not a definition of the invention, but is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. For example, the specific combination and order of steps is just one possibility, as the present method may include a combination of steps that has fewer, greater or different steps than that shown here. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that that the listing is not to be considered as excluding other, additional components or items. Other terms are to be construed using their broadest reasonable meaning unless they are used in a context that requires a different interpretation.

1. A method for downloading and installing software to a vehicle that includes a battery and vehicle electronics, comprising the steps of:
receiving an anticipatory signal at the vehicle indicating that a software package is ready or will be ready for wireless download to the vehicle, the software package includes software to be installed on the vehicle electronics;
obtaining an energy threshold level from the anticipatory signal, the energy threshold level corresponds to the expected amount of energy needed for wireless download of the software package, for installation of the software, or for both wireless download of the software package and installation of the software;
determining an energy level of the battery;
comparing the energy level of the battery to the energy threshold level; and
when the energy level of the battery is less than the energy threshold level, then making changes to battery charging parameters so that the energy level of the battery is increased, wherein the changes to the battery charging parameters are made before the wireless download of the software package, before installation of the software, or before both the wireless download of the software package and installation of the software.

2. The method of claim 1, wherein the receiving step further comprises receiving the anticipatory signal from a remote facility at the vehicle, and the anticipatory signal includes at least one piece of data that pertains to the software package and is selected from the group consisting of: a size of the software package or the software, an estimated download time of the software package, or an estimated installation time of the software.

3. The method of claim 2, wherein the obtaining step further comprises obtaining the energy threshold level from the anticipatory signal by calculating the energy threshold level from the at least one piece of data.

4. The method of claim 1, wherein the determining step further comprises determining a current mode of operation for the vehicle; and the evaluating step further comprises evaluating the current mode of operation for the vehicle before the method makes changes to the battery charging parameters.

5. The method of claim 4, when the current mode of operation is a charge mode that results in a lower system voltage and, thus, a lower energy level of the battery, then changes are made to the battery charging parameters so that the energy level of the battery is increased.

6. The method of claim 5, wherein the charge mode that results in a lower system voltage is a charge efficiency mode that is designed to improve the fuel economy of the vehicle.

7. The method of claim 1, wherein the making changes step further comprises making changes to a charge mode that results in a higher system voltage and, thus, a higher energy level of the battery.

8. The method of claim 7, wherein the charge mode is changed from a charge efficiency mode that is designed to improve the fuel economy of the vehicle to a charge recovery mode that is designed to target a maximum allowed battery charging voltage.

9. The method of claim 1, wherein the method further includes the step of:
prompting a user to determine if the user accepts the software before the wireless download of the software package, before installation of the software, or before both the wireless download of the software package and installation of the software.

10. The method of claim 1, wherein the method further includes the step of:
confirming that the vehicle is in an off state before the wireless download of the software package, before installation of the software, or before both the wireless download of the software package and installation of the software.

11. The method of claim 1, wherein the method further includes the step of:
after the changes to the battery charging parameters have been made, then requesting to wirelessly download the software package by the vehicle, to install the software, or to both wirelessly download the software package and install the software.

12. The method of claim 11, wherein a first vehicle control module wirelessly downloads the software package and a second vehicle control module installs the software, and the second vehicle control module has a greater processing speed than the first vehicle control module.

13. The method of claim 1, wherein the method further includes the step of:
after the wireless download of the software package, then charging the battery to recover at least some of the energy lost during the wireless download of the software package and the installation of the software.

14. A method for downloading and installing software to a vehicle that includes a battery and vehicle electronics, comprising the steps of:
receiving an anticipatory signal at the vehicle indicating that a software package is ready or will be ready for wireless download to the vehicle, the software package includes software to be installed on the vehicle electronics;
obtaining a requisite charge mode for the vehicle, wherein the requisite charge mode corresponds to a mode of charging the battery that is preferable for wireless download of the software package, for installation of the software, or for both wireless download of the software package and installation of the software;
determining a current charge mode for the vehicle;
evaluating whether the current charge mode is the requisite charge mode; and
when it is determined that the current charge mode is not the requisite charge mode, then making changes to battery charging parameters so that the battery energy level is increased, wherein the changes to the battery charging parameters are made before the wireless download of the software package, before installation of the software, or before both the wireless download of the software package and installation of the software.

15. The method of claim 13, wherein the receiving step further comprises receiving the anticipatory signal from a remote facility at the vehicle, and the anticipatory signal includes at least one piece of data that pertains to the software package and is selected from the group consisting of: a size of the software package or the software, an estimated download time of the software package, an estimated installation time of the software, a destination ECU for the software install, or one or more communication busses that will be active for the software install process.

16. The method of claim 14, wherein the obtaining step further comprises obtaining the energy threshold level from the anticipatory signal by calculating the energy threshold level from the at least one piece of data.

17. The method of claim 13, wherein the making changes step further comprises making changes to the charge mode that results in a higher system voltage and, thus, a higher energy level of the battery.

18. The method of claim 16, wherein the charge mode is changed from a charge efficiency mode that is designed to improve the fuel economy of the vehicle to a charge recovery mode that is designed to target a maximum allowed battery charging voltage.

19. The method of claim 13, wherein the method further includes the step of:
prompting a user to determine if the user accepts the software before the wireless download of the software package, before installation of the software, or before both the wireless download of the software package and installation of the software.

20. The method of claim 13, wherein the method further includes the step of:
confirming that the vehicle is in an off state before the wireless download of the software package, before installation of the software, or before both the wireless download of the software package and installation of the software.

21. The method of claim 13, wherein the method further includes the step of:
after the changes to the battery charging parameters have been made, then the vehicle requests to wirelessly download the software package, to install the software, or to both wirelessly download the software package and install the software.

22. The method of claim 20, wherein a first vehicle control module wirelessly downloads the software package and a second vehicle control module installs the software, and the second vehicle control module has a greater processing speed than the first vehicle control module.

23. The method of claim 13, wherein the method further includes the step of:
after the wireless download of the software package, then charging the battery to recover at least some of the energy lost during the wireless download of the software package and the installation of the software.

24. A vehicle system for downloading and installing software, comprising:
a battery that powers one or more vehicle components;
a wireless communications device powered by the battery and configured to wirelessly receive an anticipatory signal indicating that software is ready or will be ready for wireless download to the vehicle; and
a vehicle module powered by the battery, coupled to the wireless communications device, and configured to compare an energy level of the battery to an energy threshold level obtained from the anticipatory signal;
wherein the system is configured to make changes to battery charging parameters so that the energy level of the battery is increased in preparation for downloading and installing the software when the energy level of the battery is less than the energy threshold level.
